(19) United States
(12) Patent Application Publication
(10) Pub. No.: US 2022/0044210 A1
(43) Pub. Date: Feb. 10, 2022

(54) INFORMATION SERVICE SYSTEM, INFORMATION SERVICE METHOD, AND PROGRAM

(71) Applicant: Rakuten Group, Inc., Tokyo (JP)

(72) Inventor: Qifan WU, Tokyo (JP)

(73) Assignee: Rakuten Group, Inc., Tokyo (JP)

(21) Appl. No.: 17/363,271

(22) Filed: Jun. 30, 2021

(30) Foreign Application Priority Data
Aug. 7, 2020 (JP) 2020-135026

(51) Int. Cl. G06Q 20/02; G06Q 20/32; G06Q 20/40; G07B 13/00; G06F 16/29

(52) U.S. Cl. CPC G06Q 20/02; G06Q 20/326; G06Q 30/0226; G07B 13/00; G06F 16/29; G06Q 20/4015

(57) ABSTRACT

PROBLEM TO BE SOLVED: To provide an information service system and the like that can notify useful information using location information to a user terminal that does not use a location-based service.

SOLUTION: In a settlement server 200 in an information service system, an acquirer 242 acquires location information indicating a payment location where a payment was made, for example, when a taxi fare was paid by a payment application executed on a user terminal, from a settlement device that processes settlements in the taxi. A generator 243 generates regional information to be provided by an information service application of the user terminal, based on the acquired location information. Then, the transmitter 220 transmits the generated regional information to the user terminal, for example, in a push notification format.

### TECHNICAL FIELD

The present disclosure relates to an information service system, an information service method, and a program.

### BACKGROUND ART

In recent years, systems that provide various useful information to users using location information indicating the current location of the user are operated.

For example, Patent Literature 1 discloses the invention of a campaign information management system that informs a user of campaign information to increase the sales promotion effect for a product.

In the invention of this Patent Literature 1, when user's location information (whereabouts) acquired from a user terminal (a user device) such as a smartphone satisfies the notification conditions of a nearby store, a push notification of campaign information about the store is sent to the user terminal.

### CITATION LIST

### Patent Literature

Patent Literature 1: Unexamined Japanese Patent Application Publication No. 2017-004340

### SUMMARY OF INVENTION

### Technical Problem

In the invention of Patent Literature 1 as described above, it was necessary for a user terminal such as a smartphone to allow use of a location-based service in order to enable push notifications of campaign information. That is, even if an application that processes campaign information is not running on the user terminal, or the user terminal is in a sleep state (suspended state), push notifications of campaign information are made possible by using a location-based service that periodically transmits the location information of the user terminal to the server in the background.

However, there is a concern that the use of such a location-based service depletes the battery of the user terminal, thereby shortening the operating time of the user terminal. For such a reason, many users intentionally disable the use of location-based services.

In addition, in an operation when installing an application, users may unintentionally disable the use of location-based services.

In these cases, useful information using location information will not be notified to the user terminal.

In consideration of such a situation, a technology that can notify useful information using location information even to a user terminal that does not use a location-based service has been required.

The present disclosure is made in view of the above situation, and the purpose of the present disclosure is to provide an information service system, an information service method, and a program that can notify useful information using location information even to a user terminal that does not use a location-based service.

### Solution to Problem

An information service system according to a first aspect of the present disclosure is an information service system in which a settlement server and a user terminal that is capable of executing a payment application and an information service application are communicably connected to each other. The settlement server includes: an acquirer that acquires location information indicating a payment location where a payment was made from a device other than the user terminal when the payment was made by the payment application executed on the user terminal; a generator that generates regional information to be provided by the information service application, based on the location information acquired by the acquirer; and a transmitter that transmits the regional information generated by the generator to the user terminal, and the user terminal includes: a receiver that receives the regional information sent from the settlement server; and a display that displays the regional information received by the receiver.

In the information service system according to the above aspect, the user terminal may be set not to use a location-based service, and the display may display the regional information by a push notification by which the information service application is launchable.

In the information service system according to the above aspect, the user terminal may be set not to use a location-based service, and the display may be controlled by the running payment application to display the regional information.

In the information service system according to the above aspect, the display may display the regional information together with link information by which the information service application is launchable.

In the information service system according to the above aspect, the acquirer may acquire the location information from a settlement device installed in a taxi or a mobile store.

An information service method according to a second aspect of the present disclosure is an information service method performed by a settlement server that is communicably connected to a user terminal capable of executing a payment application and an information service application, and the information service method includes: an acquisition step for acquiring location information indicating a payment location where a payment was made from a device other than the user terminal when the payment was made by the payment application executed on the user terminal; a generation step for generating regional information to be provided by the information service application, based on the location information acquired at the acquisition step; and a transmission step for transmitting the regional information generated at the generation step to the user terminal.

A program according to a third aspect of the present disclosure is a program that causes a computer that is communicably connected to a user terminal capable of executing a payment application and an information service application to function as: an acquirer that acquires location information indicating a payment location where a payment was made from a device other than the user terminal when the payment was made by the payment application executed on the user terminal; a generator that generates regional information to be provided by the information service application, based on the location information acquired by the acquirer; and a transmitter that transmits the regional information generated by the generator to the user terminal.

The above-described program may be distributed and sold through a computer communication network independently of the computer on which the program is executed.

Furthermore, the information recording medium for recording the program is a non-transitory recording medium and can be distributed and sold independently of the computer. Here, the non-transitory recording medium means a tangible recording medium. The non-transitory recording medium includes, for example, a compact disk, a flexible disk, a hard disk, a magneto-optical disk, a digital video disk, a magnetic tape, a semiconductor memory, or the like. A transitory recording medium indicates a transmission medium (propagation signal) itself. The transitory recording medium includes, for example, an electrical signal, an optical signal, an electromagnetic wave, or the like. Note that a temporary storage area means an area for temporarily storing data and/or a program and is a volatile memory, such as, a random access memory (RAM).

### Advantageous Effects of Invention

According to the present disclosure, useful information using location information can be notified even to a user terminal that does not use a location-based service.

### BRIEF DESCRIPTION OF DRAWINGS

FIG. 1 is a block diagram illustrating an example of the overall configuration of an information service system according to the embodiment of the present disclosure;

FIG. 2 is a block diagram illustrating an example of the overview configuration of a typical information processing device that implements a settlement server and a user terminal;

FIG. 3 is a block diagram illustrating an example of the functional configuration of the settlement server according to the embodiment of the present disclosure;

FIG. 4 is a schematic diagram illustrating an example of settlement management information;

FIG. 5 is a schematic diagram illustrating an example of store management information;

FIGS. 6A and 6B are schematic diagrams illustrating examples of generated regional information;

FIG. 7 is a block diagram illustrating an example of the functional configuration of the user terminal according to the embodiment of the present disclosure;

FIGS. 8A and 8B are schematic diagrams illustrating examples of the regional information displayed on the user terminal by a push notification;

FIG. 9 is a flowchart for explaining the information service processing according to the embodiment of the present disclosure; and

FIGS. 10A and 10B are schematic diagrams illustrating examples of the regional information displayed while the settlement application is running.

### DESCRIPTION OF EMBODIMENTS

The embodiment of the present disclosure will be described below. In the embodiment of the present disclosure, a case where regional information is notified to a user terminal when a taxi fare is paid by a payment application of the user terminal, will be described. However, this case is an example, and, as will be described later, regional information may be notified to a user terminal when a payment is made at a mobile store for purchasing a product or the like by the payment application.

That is, the following embodiment is intended only for explanation and does not limit the scope of the present disclosure. Therefore, those skilled in the art can adopt embodiments in which each or all of the components are replaced to equivalents, and such embodiments are also included in the scope of the present invention.

(Overall Configuration)

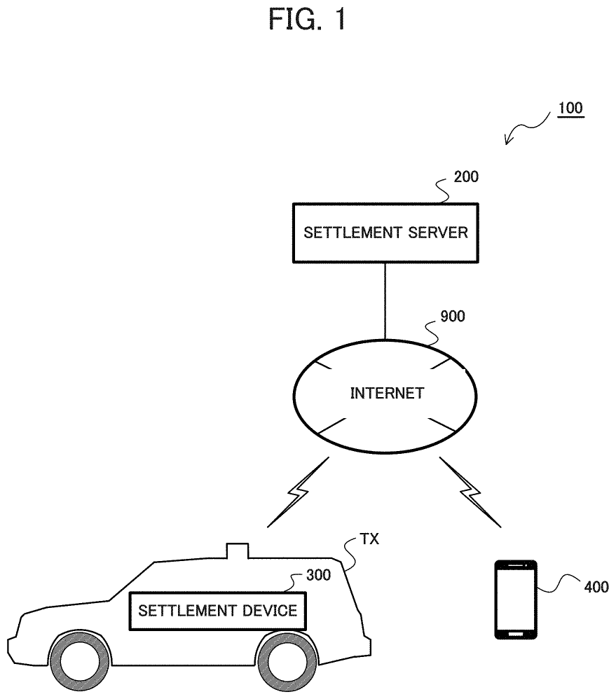

An information service system 100 according to the embodiment of the present disclosure includes, as illustrated in FIG. 1, a settlement server 200, a settlement device 300 installed in a taxi TX, and a user terminal 400 carried by a user, all of which are connected via the Internet 900. Note that, although simplified in FIG. 1, there are multiple settlement devices 300 depending on the number of taxies TX conforming to the system and multiple user terminals 400 depending on the number of users using the system.

The settlement server 200 is, for example, a computer that serves as a server and notifies, to the user terminal, regional information (as described later, useful information about stores or the like in the vicinity of the payment location) when a taxi fare is paid by a payment application running on the user terminal 400.

The settlement device 300 is installed in a taxi TX and includes, for example, a reader/writer conforming to the FeliCa (registered trademark) standard, a global positioning system (GPS) unit that can receive a GPS signal and position the current location, a mobile communication unit for communicating with the settlement server 200, and an interface for acquiring fare information from a taximeter installed in the taxi TX.

For example, the settlement device 300 transmits settlement information including the positioned location information (location information indicating the payment location) to the settlement server 200 when settling a taxi fare (electronic settlement) by reading and writing necessary information from the IC chip incorporated in the user terminal 400.

Note that the settlement method may not be limited to the electronic settlement using such an IC chip and may be an electronic settlement using a two-dimensional code represented by a QR code (registered trademark).

The user terminal 400 is, for example, a smartphone incorporating an IC chip conforming to the FeliCa (registered trademark) standard and installed with a payment application and an information service application. Note that the payment application controls payments that utilize the IC chip. In addition, the information service application is an application associated (linked) with the payment application and provides useful information to the user.

Note that the user terminal 400 is equipped with a GPS unit (a positioning unit 511 as described later), but the use of a location-based service is set to be disabled. In other words, the payment application and information service application are set not to send location information (current location) to the settlement server 200 or any other servers.

Such a user terminal 400 displays regional information sent from the settlement server 200 when paying for a taxi fare by the payment application.

(Outline Configuration of Information Processing Device)

The following will describe a typical information processing device 500 that implements the settlement server 200 and user terminal 400 according to the embodiment of the present disclosure.

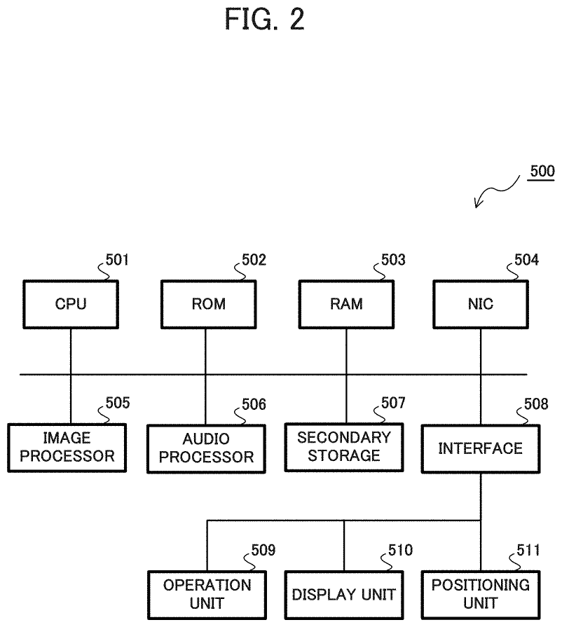

As illustrated in FIG. 2, the information processing device 500 includes a central processing unit (CPU) 501, a read only memory (ROM) 502, a random access memory (RAM) 503, a network interface card (NIC) 504, an image processor 505, an audio processor 506, a secondary storage 507, an interface 508, an operation unit 509, a display unit 510, and a positioning unit 511.

The CPU 501 controls the entire operation of the information processing device 500 and is connected to each of the components to exchange control signals and data.

The ROM 502 records an initial program loader (IPL) that runs immediately after the power is turned on, and, when the IPL runs, a program stored in the secondary storage 507 is read out on the RAM 503 and the CPU 501 starts to execute the program.

The RAM 503 is for temporarily storing data and/or a program, and retains the program and/or data read from the secondary storage 507 and other data necessary for communication.

The NIC 504 is for connecting the information processing device 500 to a computer communication network such as the Internet, and may conform to the 10BASE-T/100BASE-T standard that is used when constructing a local area network (LAN). The NIC 504 includes an analog model for connecting to the Internet using a telephone line, an integrated services digital network (ISDN) modem, an asymmetric digital subscriber line (ADSL) modem, a cable modem for connecting to the Internet through a cable-television circuit, or the like.

The image processor 505 uses the CPU 501 or an image arithmetic processor (not illustrated) equipped in the image processor 505 to process image data read from the secondary storage 507 or the like, before storing the image data in a frame memory (not illustrated) equipped in the image processor 505. The image information that is stored in the frame memory is converted into a video signal at a predetermined synchronization timing and output to outside via the interface 508 or the like. Note that, when the information processing device 500 incorporates a display device, the image processor 505 outputs the converted video signal to the display device. That is, the image processor 505 generates an image necessary for the progress of the processing performed by the information processing device 500 under the control of the CPU 501, and displays the image on an internal or external display device.

The audio processor 506 converts music data or audio data read from the secondary storage 507 or the like into an audio signal, and outputs the audio signal to outside via the interface 508 or the like. Note that, when the information processing device 500 incorporates a speaker, the audio processor 506 outputs the converted audio signal to the speaker. That is, the audio processor 506 generates a music sound or audio to be emitted in the progress of the processing performed by the information processing device 500 under the control of the CPU 501, and outputs the music sound or the like from an internal or external speaker.

The secondary storage 507 is a hard disk, a solid state drive (SSD), or the like, and stores various programs and various data necessary for controlling of the entire operation of the information processing device 500. For example, the secondary storage 507 stores a program for implementing the settlement server 200 or the like according to the present embodiment. Then, under the control of the CPU 501, the secondary storage 507 reads the stored program and/or data as needed and the RAM 503 or the like temporarily stores the program and/or data. Further, the secondary storage 507 may include, for example, an IC chip conforming to the FeliCa (registered trademark) standard.

The interface 508 conforms to standards such as HDMI (registered trademark) and universal serial bus (USB) and is connected to the operation unit 509, the display unit 510, and the positioning unit 511. Note that the interface 508 may also transmit and receive necessary information to and from an external device that is connected to the interface 508.

The operation unit 509 accepts an operation input of an operator or the like who uses the information processing device 500.

The display unit 510 draws an image according to the image data output by the image processor 505 and presents the image to an operator or the like using the information processing device 500.

The positioning unit 511 receives, for example, a GPS signal sent from a plurality of GPS satellites and positions the current location of the information processing device 500 at a predetermined timing.

Note that, instead of using such a GPS signal, the positioning unit 511 may position the current location of the information processing device 500 using a radio wave strength (reception strength or the like) from a plurality of base stations.

In addition, the information processing device 500 may include a drive unit for, such as, a digital versatile disc (DVD)-ROM instead of the secondary storage 507. In this case, the information processing device 500 reads a program and/or data from the DVD-ROM or the like mounted on the drive unit and operates in the same way as described above.

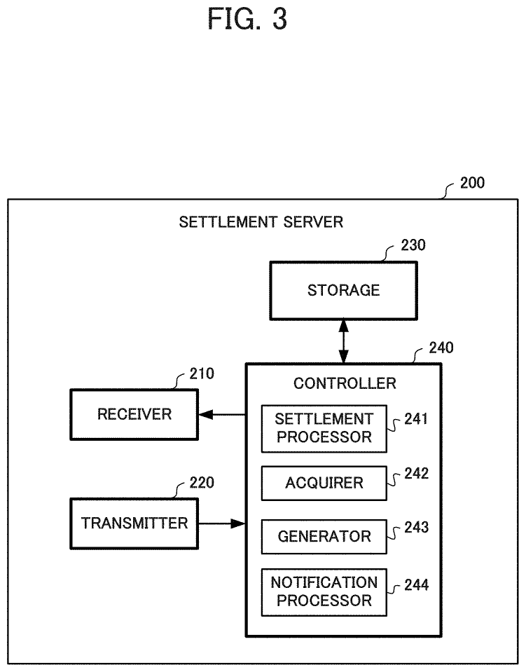

Hereinafter, the functional configuration and the like of the settlement server 200 that is implemented in the above-described information processing apparatus 500 will be described with reference to FIGS. 3 to 6. When the power is turned on to the information processing device 500 and, for example, communication with the user terminal 400 or the like is enabled, a program that causes the information processing device 500 to function as the settlement server 200 according to the present embodiment is executed to realize the settlement server 200 according to the present embodiment. As will be described later, the user terminal 400 is similarly implemented by the information processing device 500.

(Functional Configuration of the Settlement Server 200)

FIG. 3 is a block diagram illustrating an example of the functional configuration of the settlement server 200 according to the present embodiment. As illustrated in FIG. 3, the settlement server 200 includes a receiver 210, a transmitter 220, a storage 230, and a controller 240.

The receiver 210 receives information that is transmitted from the settlement device 300 or the like via the Internet 900.

For example, the receiver 210 receives settlement information sent from the settlement device 300 when a taxi fare is paid by the payment application on the user terminal 400.

As described above, the settlement device 300 is equipped with a GPS unit and positions location information indicating the payment location upon settlement processing. Then, the settlement device 300 sends settlement information including the positioned location information to the settlement server 200. As such, the receiver 210 receives the settlement information including the location information indicating the payment location.

The NIC 504 described above may function as such a receiver 210.

The transmitter 220 transmits information that is addressed to the user terminal 400 or the like via the Internet 900.

For example, the transmitter 220 transmits regional information generated by a controller 240 (a generator 243), as will be described later, to the user terminal 400. Note that the transmitter 220 may transit the regional information to the user terminal 400 in a push notification format as described later, or transmit the regional information to the user terminal 400 by e-mail. Furthermore, the transmitter 220 may transmit the regional information to the user terminal 400 in a form included in the response information to the payment application as described later.

The NIC 504 described above may function as such a transmitter 220.

The storage 230 stores, for example, settlement management information for managing settlements by the payment application and store management information for managing information about stores.

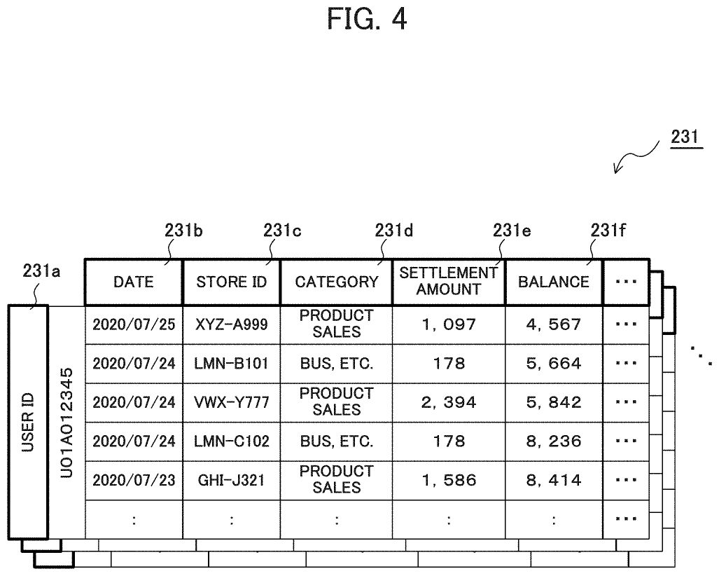

For example, the storage 230 stores settlement management information 231 as illustrated in FIG. 4.

As illustrated in FIG. 4, the settlement management information 231 includes, for example, a user ID 231a, a date 231b, a store ID 231c, a category 231d, a settlement amount 231e, and a balance 231f.

Note that the date 231b is a date on which a settlement was made. The store ID 231c is identification information of a store (including a taxi company) at which the settlement was made. Further, the category 231d is the type of settlement. Then, the balance 231f is the balance in electronic value the user possesses (for example, managed by the IC chip).

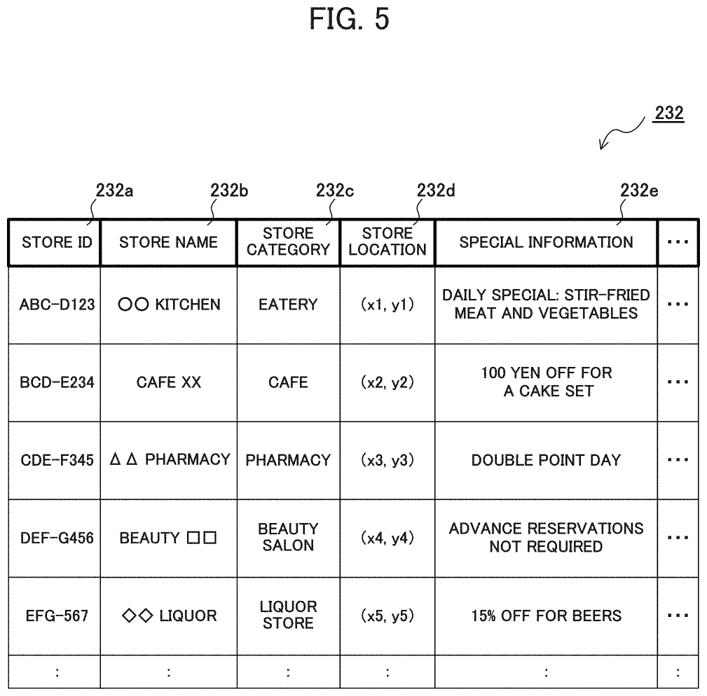

The storage 230 stores store management information 232 as illustrated in FIG. 5.

As illustrated in FIG. 5, the store management information 232 includes, for example, a store ID 232a, a store name 232b, a store category 232c, a store location 232d, and special information 232e.

Note that the store location 232d is a location where the store resides. The special information 232e is information such as a sale at the store and points that can be earned.

In addition, the storage 230 also stores user management information including the user's name, age, sex, unique identification information of the user terminal 400, and an email address.

Note that the secondary storage 507 or the like described above may function as such a storage 230.

Referring back to FIG. 3, the controller 240 controls the entire settlement server 200.

This controller 240 includes, for example, a settlement processor 241, an acquirer 242, a generator 243, and a notification processor 244.

The settlement processor 241 updates the settlement management information 231 described above in accordance with the settlement information sent from the settlement device 300.

The acquirer 242 acquires location information included in the settlement information sent from the settlement device 300. That is, the acquirer 242 acquires the location information indicating the payment location from the settlement device 300.

The generator 243 generates regional information to be provided by the information service application, based on the location information acquired by the acquirer 242.

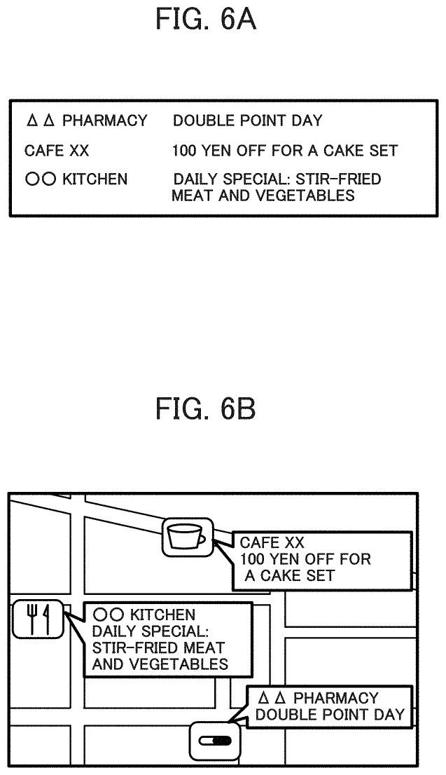

For example, the generator 243 first extracts stores that exist within a certain distance range centering on the payment location indicated by the location information, based on the store location 232d from among the store management information 232 described above. At that time, the store categories 232c of stores to be extracted may be narrowed down according to the age, sex, and/or the like of the user. Then, the generator 243 generates regional information including the store names 232b and special information 232e of the extracted stores. As a specific example, the generator 243 generates regional information as illustrated in FIG. 6A.

With regard to push notifications, recently, so-called rich push notifications (rich notifications) are also available. In this rich push notification, it is possible to send contents including images, audio, videos and/or the like to the user terminal 400 as well as conventional text (messages). As such, the generator 243 may, for example, draw a map image of a predetermined range centering on the payment location, overlay a store icon at a position on the map image corresponding to the store location 232d of the extracted store, and generate regional information describing the store name 232b and special information 232e in a callout extended from the icon. As a specific example, the generator 243 generates regional information as illustrated in FIG. 6B.

In this way, the generator 243 generates regional information that provides useful information about stores present near the payment location.

The notification processor 244 controls the transmitter 220 to transmit the regional information generated by the generator 243 to the user terminal 400.

For example, the notification processor 244 may transmit the regional information to the user terminal 400 in a push notification format using the unique identification information of the user terminal 400, or transmit the regional information to the user terminal 400 by e-mail using an e-mail address of the user terminal 400.

In addition, the controller 240 also generates a settlement history in response to an inquiry when the user instructed to inquire the settlement history through the payment application.

The above-described CPU 501 or the like may function as the controller 240 of such a configuration.

(Functional Configuration of the User Terminal 400)

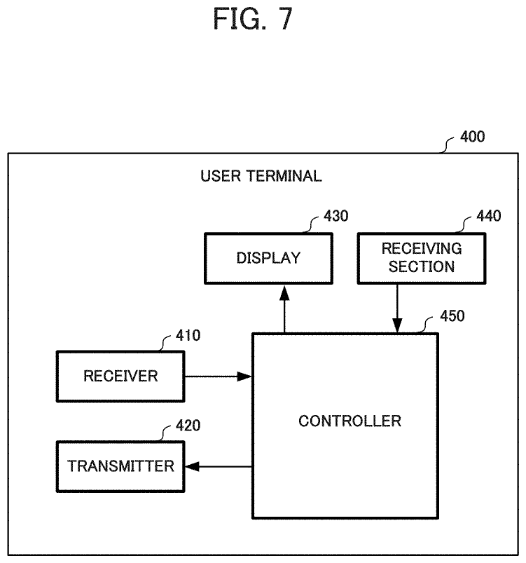

FIG. 7 is a block diagram illustrating an example of the functional configuration of the user terminal 400 according to the present embodiment. As illustrated in FIG. 7, the user terminal 400 includes a receiver 410, a transmitter 420, a display 430, a receiving section 440, and a controller 450.

The receiver 410 receives information that is transmitted from the settlement server 200 or the like via the Internet 900.

For example, the receiver 410 receives regional information that is sent from the settlement server 200.

The NIC 504 described above may function as such a receiver 410.

The transmitter 420 transmits information addressed to the settlement server 200 or the like via the Internet 900.

For example, the transmitter 420 transmits request information for requesting an inquiry of the settlement history to the settlement server 200.

The NIC 504 described above may function as such a transmitter 420.

The display 430 displays various information for reporting to the user.

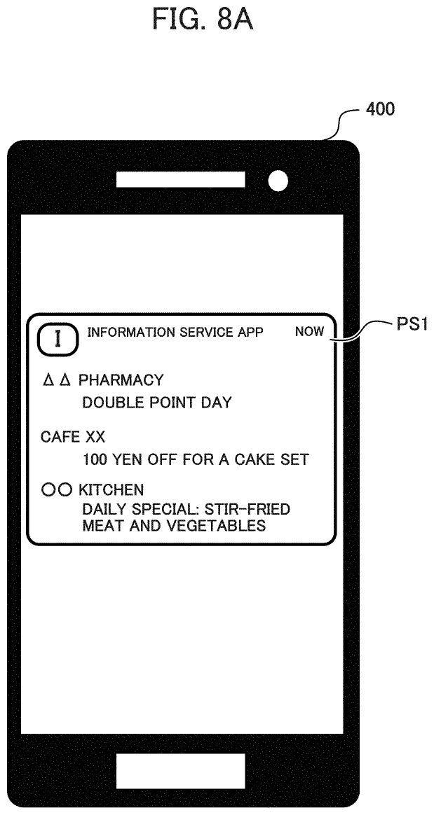

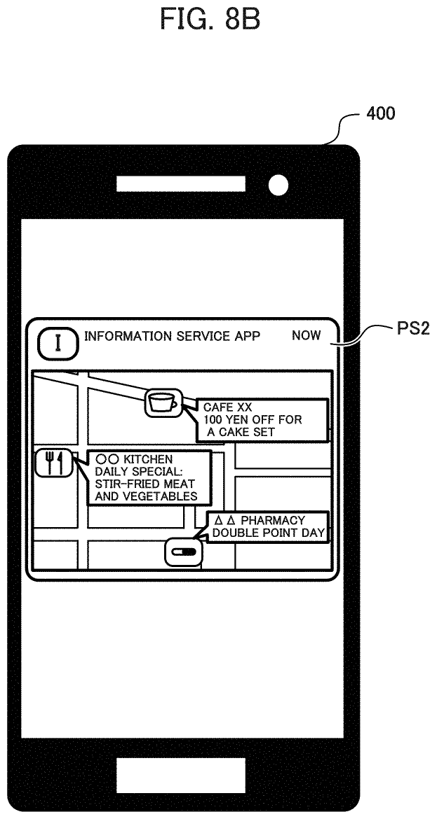

For example, when the above-described receiver 410 receives regional information that is sent in a push notification format, the display 430 displays a push notification PS1 as illustrated in FIG. 8A and/or a push notification PS2 as illustrated in FIG. 8B.

Note that the push notification PS1 illustrated in FIG. 8A is a text-only push notification, and the push notification PS2 illustrated in FIG. 8B is a rich push notification including an image. When the user touch-operates the push notification PS1 or PS2, the information service application is lauched to enable display of more detailed information about the regional information.

The display unit 510 described above may function as such a display 430.

Referring back to FIG. 7, the receiving section 440 accepts an operation from the user.

For example, the receiving section 440 is a touch panel superimposed on the display 430 and accepts an operation for the push notification PS1, PS2, or the like as illustrated in FIGS. 8A and 8B described above.

The operation unit 509 described above may function as such a receiving section 440.

The controller 450 controls the entire user terminal 400.

For example, when regional information sent from the settlement server 200 is received by the receiver 410, the controller 450 controls the display 430 to display a push notification PS1, PS2 as illustrated in FIGS. 8A, 8B described above. Then, when the push notification PS1, PS2 is touch-operated by the user and the receiving section 440 accepts the operation content, the controller 450 launches the information service application.

The above-described CPU 501 or the like may function as such a controller 450.

(Operation of the Settlement Server 200)

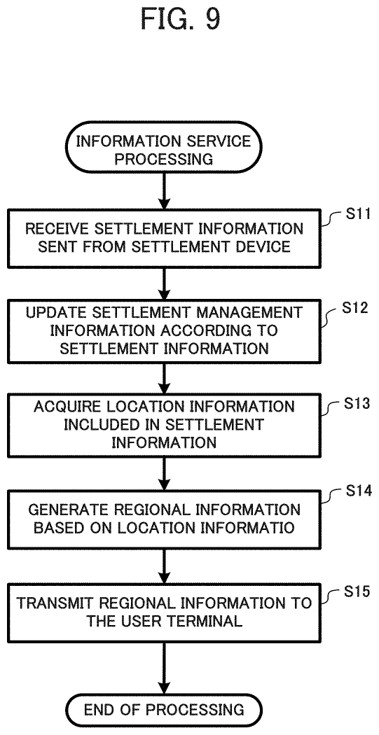

Hereinafter, the operation of the settlement server 200 in the information service system 100 will be described with reference to FIG. 9. FIG. 9 is a flowchart illustrating the flow of information service processing performed by the settlement server 200.

This information service processing starts, for example, each time settlement information is sent from the settlement device 300.

First, the settlement server 200 receives settlement information sent from the settlement device 300 (step S11).

That is, the receiver 210 receives the settlement information sent from the settlement device 300 via the Internet 900 when a taxi fare is paid by the payment application on the user terminal 400.

The settlement server 200 updates the settlement management information stored in the storage 230 in accordance with the received settlement information (step S12).

That is, the controller 240 (settlement processor 241) updates the settlement management information 231 as illustrated in FIG. 4 in accordance with the settlement information sent from the settlement device 300.

The settlement server 200 acquires the location information included in the settlement information (step S13).

That is, the controller 240 (acquirer 242) acquires location information indicating the payment location from the settlement device 300.

The settlement server 200 generates regional information based on the acquired location information (step S14).

That is, the controller 240 (generator 243) generates regional information to be provided by the information service application based on the location information indicating the payment location.

For example, the controller 240 first extracts stores that exist within a certain distance range centering on the payment location indicated by the location information, based on the store location 232d from among the store management information 232 as illustrated in FIG. 5. At that time, the store categories 232c of stores to be extracted may be narrowed down according to the age, sex and/or the like of the user. Then, the controller 240 generates regional information including the store names 232b and special information 232e of the extracted stores. As a specific example, the generator 243 generates regional information as illustrated in FIG. 6A. Alternatively, the generator 243 may generate regional information as illustrated in FIG. 6B including an image.

The settlement server 200 transmits the generated regional information to the user terminal 400 (step S15).

That is, the transmitter 220 controlled by the controller 240 (notification processor 244) transmits the regional information generated at step S14 to the user terminal 400 via the Internet 900. At that time, the controller 240 may cause to transmit the regional information to the user terminal 400 in a push notification format, or cause to transmit the regional information to the user terminal 400 by e-mail.

Through such information service processing, when a taxi fare is paid by the payment application running on the user terminal 400, regional information is generated based on the location information included in the settlement information, and the regional information is notified to the user terminal 400. That is, since the regional information based on the location information positioned by the settlement device 300 is notified to the user terminal 400, the user terminal 400 does not need to position the location information.

As the result, useful information using location information can be notified even to a user terminal 400 that does not use a location-based service.

### OTHER EMBODIMENTS

Although a case where regional information is transmitted to the user terminal 400 by a push notification or e-mail has been described in the above embodiment, the regional information may be transmitted to the user terminal 400 in a form included in the response information to the payment application.

For example, when a payment for a taxi fare is made while displaying the home screen of the payment application, the payment details are sent as response information from the settlement server 200. As such, the settlement server 200 includes regional information as illustrated in FIGS. 6A, 6B described above in the response information and transmits the response information to the user terminal 400.

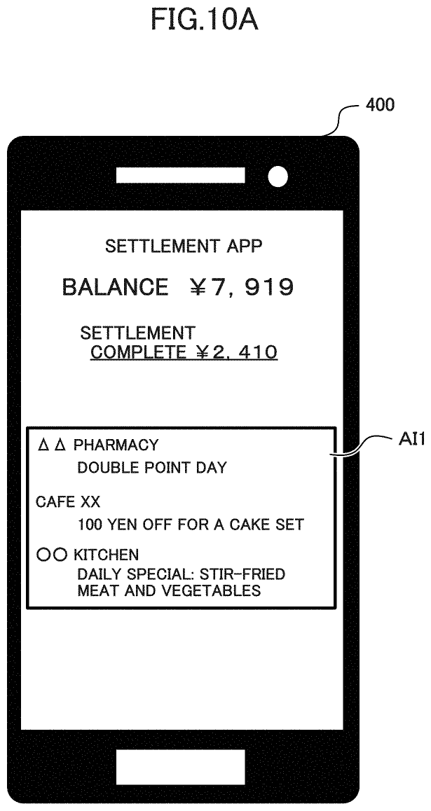

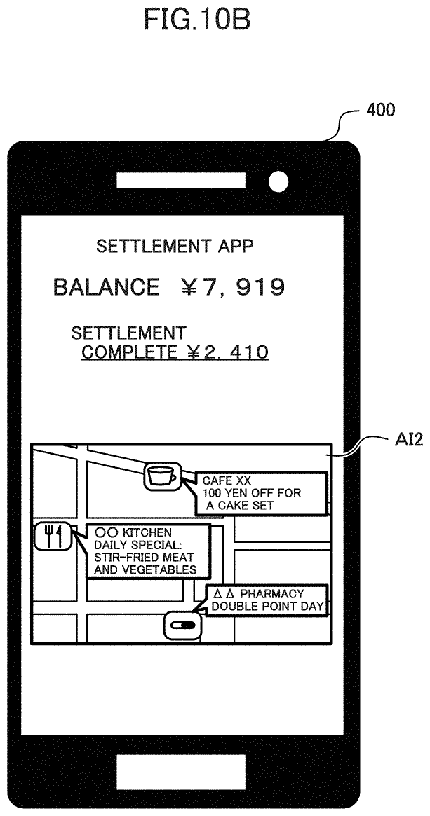

In such a case, the user terminal 400 is controlled by the running payment application, and the receiver 410 receives the response information including the regional information. Then, the display 430 controlled by the payment application displays the regional information AI1 as illustrated in FIG. 10A and/or the regional information AI2 as illustrated in FIG. 10B.

Note that the information service application may be launched when the regional information AI1 and/or AI2 is touch-operated by the user. In such a case, the display 430 displays the regional information AI1 and/or AI2 with link information that can launch the information service application.

Further, although a case where one (one type of) information service application is associated with the settlement application has been described in the above embodiment, a plurality of information service applications may be associated with the settlement application.

In such a case, in the settlement server 200, the controller 240 (generator 243) generates regional information according to each information service application. For example, for an information service application that provides tourist information, the controller 240 extracts a sightseeing spot near the payment location and generates regional information about the extracted sightseeing spot. Then, the transmitter 220 transmits each generated regional information to the user terminal 400.

In the user terminal 400, each regional information may be displayed by a push notification, or each regional information may be displayed on the settlement application.

Further, although a case in which the settlement device 300 is installed in a taxi TX has been described in the above embodiment, the settlement device 300 may be installed in a mobile store (for example, a simple store converted from a truck or a bus).

In such a case, when a payment is made at the mobile store for a purchased product or the like by the payment application, the regional information is notified to the user terminal 400.

Furthermore, in addition to these taxi TX and mobile store, the settlement device 300 may be installed at a normal store where the location position is stationary. In such a case, since the payment location does not change, the GPS unit may be omitted from the settlement device 300 and the location of the settlement device 300 may be managed on the settlement server 200 side.

Further, although a case where the settlement server 200 generates regional information has been described in the above embodiment, other servers (for example, a server that the information service application accesses) may generate regional information.

For example, the settlement server 200 transmits location information (location information indicating the payment location) to another server so that the other server stores the store management information 232 as illustrated in FIG. 5. In such a case, the other server generates regional information, based on the location information, in a similar manner as the settlement server 200 described above, and replies the generated regional information to the settlement server 200. Then, the settlement server 200 notifies the user terminal 400 of the regional information replied from the other server. Note that the other server may instead notify the user terminal 400 of the regional information.

Thus explained, the present disclosure can provide an information service system, an information service method, and a program that can notify useful information using location information even to a user terminal that does not use a location-based service.

### REFERENCE SIGNS LIST

100 Information service system
200 Settlement server
210 Receiver
220 Transmitter
230 Storage
240 Controller
241 Settlement processor
242 Acquirer
243 Generator
244 Notification processor
300 Settlement device
400 User terminal
410 Receiver
420 Transmitter
430 Display
440 Receiving section
450 Controller
500 Information processing device
501 CPU
502 ROM
503 RAM
504 NIC
505 Image processor
506 Audio processor
507 Secondary storage
508 Interface
509 Operation unit
510 Display unit
511 Positioning unit
900 Internet

1. An information service system in which a settlement server and a user terminal that is capable of executing a payment application and an information service application are communicably connected to each other,
the settlement server comprising:
an acquirer that acquires location information indicating a payment location where a payment was made from a device other than the user terminal when the payment was made by the payment application executed on the user terminal;
a generator that generates regional information to be provided by the information service application, based on the location information acquired by the acquirer; and
a transmitter that transmits the regional information generated by the generator to the user terminal, and
the user terminal comprising:
a receiver that receives the regional information sent from the settlement server; and
a display that displays the regional information received by the receiver.

2. The information service system according to claim 1, wherein
the user terminal is set not to use a location-based service, and
the display displays the regional information through a push notification by which the information service application is launchable.

3. The information service system according to claim 1, wherein
the user terminal is set not to use a location-based service, and
the display is controlled by the running payment application to display the regional information.

4. The information service system according to claim 3, wherein the display displays the regional information together with link information by which the information service application is launchable.

5. The information service system according to claim 1, wherein the acquirer acquires the location information from a settlement device installed in a taxi or a mobile store.

6. An information service method performed by a settlement server that is communicably connected to a user terminal capable of executing a payment application and an information service application, the information service method comprising:
an acquisition step for acquiring location information indicating a payment location where a payment was made from a device other than the user terminal when the payment was made by the payment application executed on the user terminal;
a generation step for generating regional information to be provided by the information service application, based on the location information acquired at the acquisition step; and
a transmission step for transmitting the regional information generated at the generation step to the user terminal.

7. A program that causes a computer that is communicably connected to a user terminal capable of executing a payment application and an information service application to function as:
an acquirer that acquires location information indicating a payment location where a payment was made from a device other than the user terminal when the payment was made by the payment application executed on the user terminal;
a generator that generates regional information to be provided by the information service application, based on the location information acquired by the acquirer; and
a transmitter that transmits the regional information generated by the generator to the user terminal.
